(19) United States
(12) Patent Application Publication
(10) Pub. No.: US 2002/0113191 A1
(43) Pub. Date: Aug. 22, 2002

(54) Integrated MEMS stabiliser and shock absorbance mechanism

(76) Inventors: Stephen Rolt, Ware (GB); Gordon D. Henshall, Harlow (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 09/871,267

(22) Filed: May 31, 2001

Related U.S. Application Data
(63) Continuation-in-part of application No. 09/747,696, filed on Dec. 22, 2000.

(51) Int. Cl. F16M 13/02

(52) U.S. Cl. 248/550

(57) ABSTRACT

An integrated MEMS stabilizer comprises a MEMS platform connected to at least one submount and integrated support means for the MEMS platform including a vibration stabilization mechanism. The vibration stabilization mechanism provides at least one connection between the submount and the MEMS platform, and reduces the amplitude of any external vibration experienced by the MEMS platform. The stabilization mechanism provided by the stabilizer enables any MEMS device or component formed or attached to the MEMS platform to maintain its operational performance even when exposed to vibrational disturbance. The stabilization mechanism may further provide protection against shock for example, by monitoring the integrated MEMS stabilizer on a slab of suitable visco elastic material, e.g. Sorbothane™.

### RELATED APPLICATIONS

This application is a continuation-in-part of U.S. patent application Ser. No. 09/747,969, entitled “INTEGRATED MEMS STABILISER”, from which priority is claimed.

### BACKGROUND OF THE INVENTION

The invention relates to an integrated micro-electromechanical system (MEMS) stabiliser which stabilises a MEMS component and/or device against vibration and shock, to a method of manufacturing an integrated MEMS stabiliser and shock absorber, and to related aspects. The invention can provide stabilisation passively or actively by providing damping vibration. The invention further relates particularly to an integrated MEMS stabiliser having an integrated MEMS accelerometer which enables active vibration damping to be provided. The invention further relates to a shock absorbing mechanism which provides protection for MEMS components and/or devices against shock, and to an optical switch which includes a vibrational and/or shock protection system

A MEMS device is a mechanical system which is provided on a chip, for example on a silicon chip. A MEMS device can be integrated with on-chip control and communication electronics. MEMS devices include MEMS components which are sensitive to vibrational disturbance. This sensitivity has several adverse side-effects. Shock and extreme vibration may damage a MEMS component, and even at smaller amplitudes degradation in the performance of a MEMS device may occur. The term shock generally refers to a sudden force-generating event, for example, when a MEMS component is dropped during transit and so can be distinguished from the term vibration, which generally refers to oscillatory motion in which a device is subjected to continuously varying g-loads along one or more axes.

MEMS components are constructed on a very small scale and generally have a mass of no more than a few microgrammes. Whilst small amplitude vibration normally results in a performance degradation which does not permanently damage the MEMS component, if a MEMS component is exposed to prolonged or repeated vibrational disturbance, the performance degradation can affect the functionality of the device. A MEMS component which experiences a large amplitude vibrational disturbance or shock, such as may occur, for example, during transportation of the device, may incur permanent damage.

The deployment of optical MEMS devices in communications equipment in the urban environment is likely to expose such devices to sources of vibration such as passing traffic noise, etc. Accordingly, in the absence of any appropriate damping mechanism being provided, such MEMS devices would need to comprise components selected to provide a sufficiently high resonance frequency for the MEMS device for vibrational effects to be minimised. This is an additional design constraint which it is desirable to avoid.

In the laboratory, MEMS devices are constructed and tested to withstand vibrations over a range of frequencies without any permanent damage being incurred. For example, passive optical components are usually tested over frequencies ranging from 10 Hz to 2000 Hz, under accelerations of up to 20 g (where g=9.8 ms⁻²) or forces creating maximum displacements of the MEMS device from equilibrium up to 1.52 mm (whichever is less) to ensure that the components are not permanently damaged. However, the degradation in the performance of MEMS device due to prolonged, or repeated exposure to vibrational noise has not been hitherto addressed in the art.

Whereas the maximum random vibration, or noise power per unit bandwidth, that a mobile device is usually constructed to tolerate is over 10-200 Hz, 1 m²s⁻³; and, over 200 Hz to 500 Hz, 0.3 m²s⁻³ these ranges apply only to the device remaining physically undamaged by exposure to such frequencies. The ranges of tolerance do not reflect any performance degradation which may occur if the device is exposed to any vibration over a prolonged time within this range of frequencies, under operating conditions.

Machinery induced noise, traffic noise etc., generally produce vibration With maxima in the region of 30 Hz to 60 Hz. Whilst this is likely to be within the tolerance levels for no permanent damage to a MEMS device to occur, exposing a MEMS device to such sources of noise is likely to induce a degradation of performance.

### OBJECT OF THE INVENTION

The invention seeks to obviate and/or mitigate the above disadvantages associated with exposing a MEMS device to vibration and/or shock by providing a stabilising mechanism for MEMS components and devices. The stabilising mechanism may be provided integrally with the MEMS components, such that a stabiliser and MEMS device can be manufactured monolithically using similar process steps to those used to provide MEMS devices not having a stabilising mechanism.

Advantageously, the invention seeks to overcome any performance degradation of a MEMS device deployed in the urban environment, by providing a suitable damping mechanism, and to mitigate potential damage during shipping of a MEMS device by shock.

Despite the small scale of MEMS devices and their integration into silicon-type chips it is advantageous if a MEMS scale stabilisation mechanism against vibrational disturbance and/or shock can be provided.

The MEMS device may be provided with a passive vibration damping mechanism, which will prevent performance degradation when subject to vibration within a range of frequencies, such as that of passing vehicular traffic noise. Such noise could affect the performance of a MEMS minor device deployed in an urban environment near a busy road.

The stabilising mechanism may provide passive vibration isolation, or the stabilising mechanism may induce counter vibrations to actively reduce the effect of external sources of vibrational noise. Such an integrated stabilising mechanism provides several advantages, including ease of manufacturing stabilised devices, reduction in costs, and improved reliability. In particular, by providing an integrated MEMS accelerometer, the invention enables vibrationally stabilised MEMS devices to be more easily manufactured.

### SUMMARY OF THE INVENTION

Accordingly, one object of the invention seeks to provide a stabiliser for a MEMS component. Advantageously, the stabiliser is provided integrally with the MEMS component.

Another object of the invention seeks to provide a method of manufacturing an integrated stabiliser for a MEMS component. Advantageously, the method uses the same technology and processes as in the manufacture of a MEMS component.

Another object of the Invention seeks to provide a method of manufacturing a stabilised MEMS component. Advantageously, the method uses the same technology and processes as in the manufacture of a MEMS component.

Another object of the invention Seeks to provide a method of stabilising a MEMS component.

Another object of the invention seeks to provide an integrated MEMS accelerometer.

Yet another object of the invention seeks to provide a resilient integrated member for a MEMS component.

Another object of the invention seeks to provide a MEMS shook absorber.

Another object of the invention seeks to provide an optical switch which includes a vibrational and/or shock protection system. References to a MEMS component include a reference to a MEMS device comprising at least one MEMS component.

A first aspect of the invention seeks to provide micro mechanical systems (MEMS) stabiliser for a MEMS component, the stabiliser comprising: at least one submount; and at least one stabilising connection connecting the submount to the MEMS component, wherein the stabiliser provides a stabilisation mechanism to reduce the amplitude of a force displacing the MEMS component from its equilibrium position.

The force may act as a shock on the MEMS component. Alternatively, the force may act as a vibrational disturbance on the MEMS component.

Preferably, the stabiliser is integrated with the MEMS component.

Preferably, at least one stabilising connection is taken from the group including a resilient member, a cantilevered member. Preferably, at least one stabilising connection comprises a viscoelastic material.

The force may act as a vibrational disturbance on the MEMS component. The stabilising mechanism may include: a vibration detector detecting vibration of the MEMS component, and a vibrator providing vibrations which damp detected vibrations in accordance the feedback from the vibration detector. Preferably, the stabilising mechanism includes: an accelerometer detecting vibration of the MEMS component; and a vibrator providing vibrations which damp detected vibrations in accordance the feedback from the vibration detector.

Preferably, if the force acts as a vibrational disturbance on the MEMS component, the stabilising mechanism includes: an accelerometer detecting vibration of the MEMS component which degrade the performance of the MEMS component, and a vibrator providing vibrations which damp detected vibrations degrading the performance of the MEMS component in accordance the feedback from the vibration detector.

Preferably, the submount has a resonant frequency below 30 Hz, and wherein the stabilising mechanism stabilises the MEMS component from vibration at frequencies above 30 Hz. More preferably, the submount has a resonant frequency below 10 Hz, and wherein the vibration stabilising mechanism stabilises the MEMS component from vibration at frequencies above 10 Hz.

A second aspect of the invention seeks to provide a method of manufacturing an integrated stabiliser for a MEMS device, the method comprising integrating at least one submount and at least one stabilising connection connecting the submount to a component of the MEMS device with components of the MEMS device during manufacture of the MEMS device, wherein the stabiliser provides a stabilisation mechanism to reduce the amplitude of a force displacing the MEMS device from its equilibrium position.

A third aspect of the invention seeks to provide a method of manufacturing a stabilised MEMS device, comprising the step of integrating the manufacture of a stabiliser with the step of manufacturing at least one component of the MEMS device.

A fourth aspect of the invention seeks to provide an integrated MEMS accelerometer for detecting vibration of a MEMS component, the accelerometer being provided integrally with a MEMS platform attached to the MEMS component.

Preferably, a vibration detection mechanism providing feedback to a vibrator providing vibrations which damp detected vibrations.

A fifth aspect of the invention seek to provide a stabilising connector for connecting a MEMS component to a submount, the stabilising connector comprising a resilient member formed integrally with the MEMS component

Preferably, the stabilising connector comprises a resilient member.

Preferably, the resilient member is a silicon based member. Alternatively, the resilient member may be a viscoelastic member, for example, Sorbothane™.

The stabilising connector may comprise a resilient, silicon based member providing a cantilever-like connection between the MEMS component and the submount.

The stabilising connector may comprise a resilient, silicon based member providing a spring-like connection between the MEMS component and the submount.

A sixth aspect of the invention seeks to provide a biasing MEMS member comprising a plurality of resilient, flexed, elements arranged in juxtaposition such the overall arrangement of elements provides a biasing action, wherein each element can be formed by a monolithic process. Preferably, the biasing MEMS member is for a MEMS device and is formed integrally with at least one component of the MEMS device.

A seventh aspect of the invention seeks to provide a vibration stabilised MEMS component mounted on a MEMS platform connected to at least one submount and including integrated support means for the MEMS platform including a vibration stabilising mechanism, wherein the vibration stabilising mechanism provides at least one stabilising connection between the submount and the MEMS platform, wherein the vibration stabilising mechanism reduces the amplitude of any external vibration experienced by the MEMS component.

Preferably, the vibration isolation system comprises a vibration actuator and vibration detection means, whereby active feedback from the vibration detecting means controls the amount of vibration induced by the vibration actuator, to actively damp vibration from external sources which are affecting the performance of the MEMS component.

An eighth aspect of the invention seeks to provide a micro mechanical systems (MEMS) stabiliser for a MOMS platform, the stabiliser comprising: at least one submount; and at least one stabilising connection connecting the submount to the MEMS platform, wherein the stabiliser provides a vibration stabilisation mechanism to reduce the amplitude of any vibrational disturbance acting on the MEMS platform.

Preferably, the stabiliser is integrated with the MEMS platform.

A ninth aspect of the invention seeks to provide a MEMS optical switch incorporating at least one micro mechanical systems (MEMS) stabiliser for a MEMS component of the MEMS optical switch, the stabiliser comprising: at least one submount; and at least one stabilising connection connecting the submount the MEMS component, wherein the stabiliser provides a vibration stabilisation mechanism to reduce the amplitude of any vibrational disturbance acting on the MEMS component.

A tenth aspect of the invention seeks to provide a micro mechanical systems (MEMS) shock absorber for a MEMS component, the shock absorber connected to said MEMS component, the shock absorber comprising at least one submount and at least one stabilising connection connecting one of the said submounts to the MEMS component, wherein the shock absorber provides a shook stabilisation mechanism to reduce the amplitude of any shock acting on the MEMS component.

Preferably, the shock absorber is integrated with the MEMS component.

Preferably, the shock absorber further comprises a second submount connected to the said first submount by at least one resilient member providing a dashpot mechanism for said first submount.

Preferably, at least one stabilising connection comprises a resilient member.

The MEMS component may be further stabilised against vibration by a vibration stabilising mechanism provided integrally with said MEMS component.

An eleventh aspect of the invention seeks to provide an optical switch including at least one MEMS component and having a micro-mechanical vibration and shock protection system including at least one MEMS stabiliser comprising at least one stabilising submount; and at least one stabilising connection connecting the stabilising submount to the MEMS component, wherein the stabiliser provides a vibration stabilisation mechanism to reduce the amplitude of any vibrational disturbance acting on the MEMS component, and at least one MEMS shock absorber for the MEMS component; the shock absorber comprising: at least one submount; and at least one stabilising connection connecting the submount to the MEMS component, wherein the shock absorber provides a shock stabilisation mechanism to reduce the amplitude of any shock acting on the MEMS component.

Advantageously, the provision of a stabiliser for shock and/or vibration in a MEMS optical switch enables the MEMS switch to operate in environments where vibrational noise could otherwise affect the performance of its switching operation.

Advantageously, the invention enables a MEMS device to be deployed in environments which may have high noise levels which would otherwise affect the performance of the MEMS device, such as in a road-side installation.

Advantageously, the invention provides an integrated stabiliser for a MEMS device which can be formed integrally with the components of the MEMS device using the same lithographic techniques.

Advantageously, an integrated accelerometer for a MEMS device, which can be formed integrally with a platform on which MEMS devices can be mounted. In this manner, the invention provides passive and/or active stabilisation of the MOMS device against vibrational disturbance.

Advantageously, the stabiliser provides for protection against shock during shipping of the MEMS device.

Any of the above features maybe incorporated with each other and/or with any of the above aspects as Would be apparent to a person skilled in the art.

### BRIEF DESCRIPTION OF THE DRAWINGS

For better understanding of the invention to show how the same may be carried into effect, there will now be described by way of example only specific embodiments, methods and processes according to the present invention with reference to the accompanying drawings,

FIG. 1 shows a side view of a MEMS stabiliser for a MEMS device according to one embodiment of the invention;

FIG. 2 shows an overhead view of a MEMS platform;

FIG. 3 shows light paths reflected from MEMS mirrors mounted on a MEMS platform;

FIG. 4A shows a MEMS stabiliser;

FIG. 4B shows a MEMS stabiliser providing passive stabilisation of a MEMS device;

FIG. 4C shows a MEMS stabiliser providing active stabilisation of a MEMS device;

FIG. 5 shows an overhead view of a MEMS platform stabilised by a stabiliser according to another embodiment of the invention.

FIG. 6 shows a sketch of vibrational amplitude against frequency for a MEMS device;

FIG. 7 shows a MEMS device actively stabilised by a MEMS stabiliser;

FIG. 8 shows how feedback from a vibration detector is provided to a vibration actuator for a MEMS device;

FIG. 9 shows a first simple mechanical model of a shock absorbing mechanism according to the invention;

FIG. 10 is a sketch of a graph illustrating the shock test specification requirement;

FIG. 11 is a sketch illustrating the safe operational characteristics of a MEMS device which is damped in accordance with the invention;

FIG. 12 is a sketch of a second simple mechanical model of a shock absorbing mechanism according to the invention;

FIG. 13A is a sketch of a graph illustrating actuator displacement vs. platform resonance frequency in a critically damped MEMS device;

FIGS. 13B, and 13C sketch platform displacement and actuator displacement in a second critically damped MEMS device;

FIG. 14 illustrates a MEMS device in more detail which conforms to the invention.

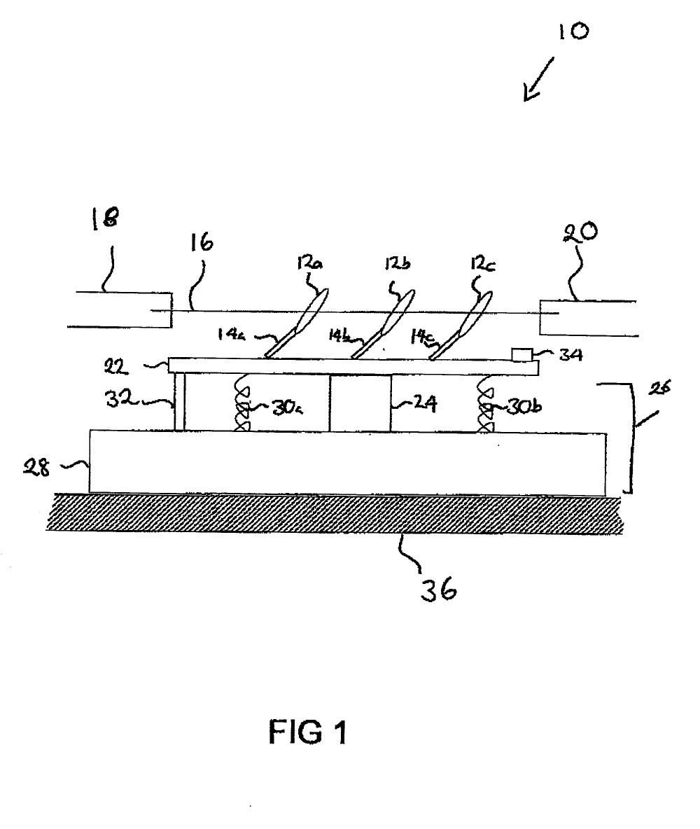

Referring now to FIG. 1, a vibration stabilised MEMS device 10 is illustrated in side view. The MEMS device 10 provides a function which is sensitive to vibration as it includes vibration sensitive elements whose performance may be adversely affected by vibrational disturbance. For example, in FIG. 1 such vibration sensitive elements include MEMS components such as MEMS mirrors 12a, b, c. Each MEMS mirror is mounted on a mirror actuator 14a, b, c respectively, in accordance with known MEMS mirror technology.

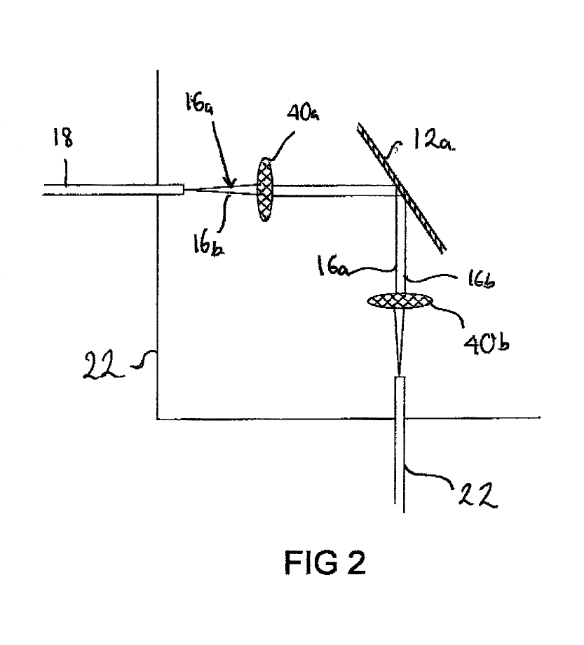

Each one of the MEMS mirrors can be positioned by its respective actuator to intercept and reflect right from light beam 11 such as can emerge from an optical fibre, for example, optical fibre 18. When actuated, each MEMS mirror must be positioned accurately to reflect the light into the insertion region of another optical fibre (not shown, see for example, FIG. 2).

Any vibration of the MEMS device 10 can affect the relative alignment of the MEMS mirrors 12a, . . . ,c, the optical fibre(s) from which a light beam emerges (for example, optical fibre 18), and the optical fibre(s) into which a light beam is inserted, (for example, optical fibre 20). Accordingly, the aforementioned components of the MEMS device 10 form elements which are sensitive to vibration.

The functional performance of the MEMS device 10 is affected by vibrational disturbance as vibrations may degrade the switching function the MEMS mirrors 12a, . . . ,c provide.

A MEMS platform 22 provides a stabilising support for the ends of the optical fibres 18, 20 and for the MEMS mirror components. The MEMS platform 22 is suitably supported. The support may include at least one non-biased support member, for example, in FIG. 1, a central platform support member 24 is provided, and additional support is provided by at least one vibrational stabilising connector, for example, stabilizing connectors 30a, 30b in FIG. 1. The stabilising supports comprise a suitable MEMS stabiliser 2f and are configured to stabilise the MEMS platform as much as possible. For example, the stabiliser 26 may comprise a number of stabilising connectors which are suitably arranged around the centre of mass of the MEMS device, for example, symmetrically. The support member 24 and/or the vibrational stabilising connectors 30a, 30b may be connected directly to a base 386 of the package material which packages the MEMS device 10, or, as FIG. 1 shows, a submount 28 may be provided. The submount 28 provides a base from which the stabilising connectors 30a, 30b can extend to provide a biased support for the MEMS platform 22. The submount 28 and stabilising connectors 30a, 30b together with central support member 24 provide a passive stabilising mechanism for the MEMS platform 22 and attached MEMS components. In alternative embodiments of the invention, the vibrational stabilising connectors provide the sole source of support, and another non-biased support member is not provided.

In FIG. 1, additional, active stabilisation is provided by the vibration actuator 32 which provides damping vibrations to the MEMS platform 22 and any MEMS components, such as MEMS mirrors 12a, . . . ,c provided on the MEMS platform 22, to reduce the amplitude of any vibrations. The mechanism by which active damping is effectuated is described herein below in more detail.

The vibrations the MEMS platform and components experience are determined by a suitable vibration detector 34. In FIG. 1, the vibration detector 34 comprises a MEMS accelerometer which is mounted on the surface of the MEMS platform 22. In the best mode of the invention contemplated by the inventor, the accelerometer is formed integrally with the MEMS platform 22 so as to provide an integrated MEMS accelerometer. Thus the MEMS accelerometer may be formed lithographically using a MEMS manufacturing process.

FIG. 2 shows an overhead view of a portion of the MEMS platform 22 shown in FIG. 1 demonstrating the necessity for accurate positioning of a MEMS mirror, such as mirror 12a. In FIG. 2, the light beam 16 is reflected into optical fiber 38 (not shown in FIG. 1), by mirror 12a positioned in Fe path of the light beam 16. If the position of the mirror 12a is not sufficiently accurate, reflected light i6 will not be focussed precisely at the centre of the optical fiber 38. If the reflected light 16 is not thus positioned, a loss of intensity and/or error may be generated.

Collimating lens 40a, 40b collimate the light beams 16a,b from fibre 16 into fiber 18. However, if mirror 12a experiences any vibrational disturbance, then signal insertion loss can occur and the quality of the light signal inserted into fibre 38 decease. If the mirror 12a vibrates with a sufficiently high amplitude, the signal insertion loss may increase and the signal may acquire an unacceptable error rate, at which point the mirror performance is degraded below its operational tolerance.

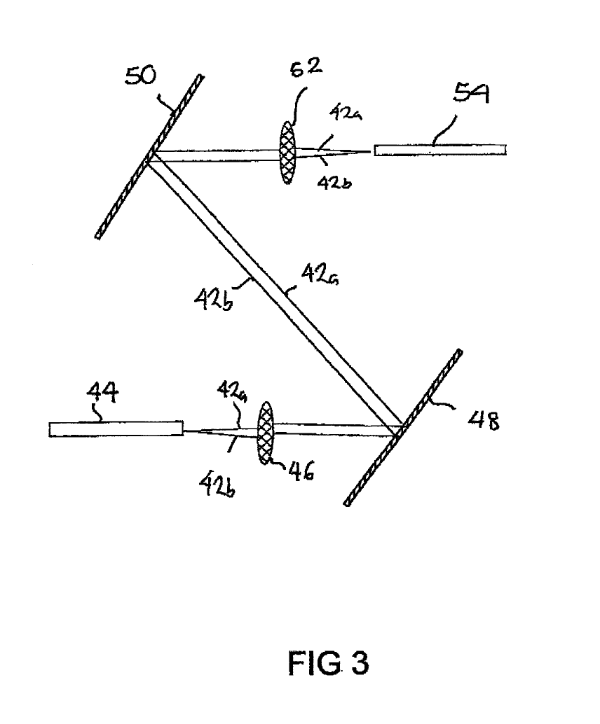

In the case where two mirrors may be required to perform an appropriate switching function, such as FIG. 3 illustrates, the sensitivity of the switching action of the MEMS mirrors is exacerbated. In FIG. 3, several components are mounted on a MEMS platform (not shown) which provide an optical switching function. In FIG. 3, light beams 42a, 42 emerging from fibre 44 are collimated by collimating lens 46. The collimated beams are reflected off a first MEMS mirror 48, and then off a second MEMS mirror 50 before being collimated by collimating lens 52 into fibre 54. Any vibration of the MEMS platform (not shown) affecting the MEMS mirror components 48, 50 mounted on the platform degrades the reflection functionality two fold. Beams Which are inaccurately reflected due to vibration of the MEMS mirror 48 are further inaccurately reflected due to the vibration of the MEMS mirror 50. In general, as the complexity of a MEMS device increases, the interdependence of the MEMS components can exacerbate the effects of any vibration on the overall performance of the MEMS device.

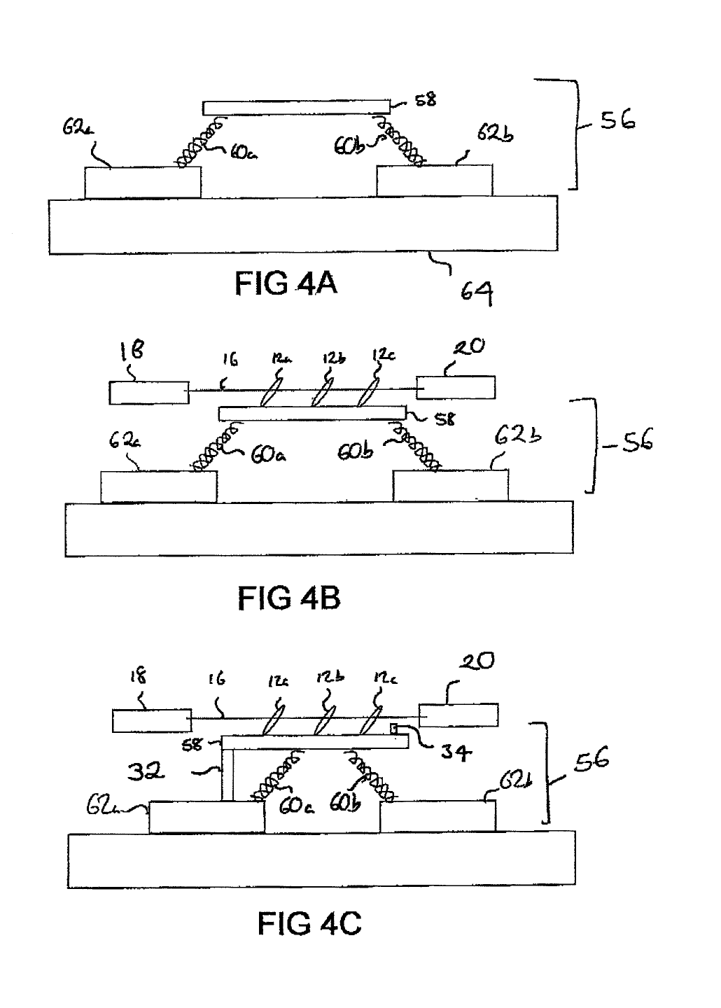

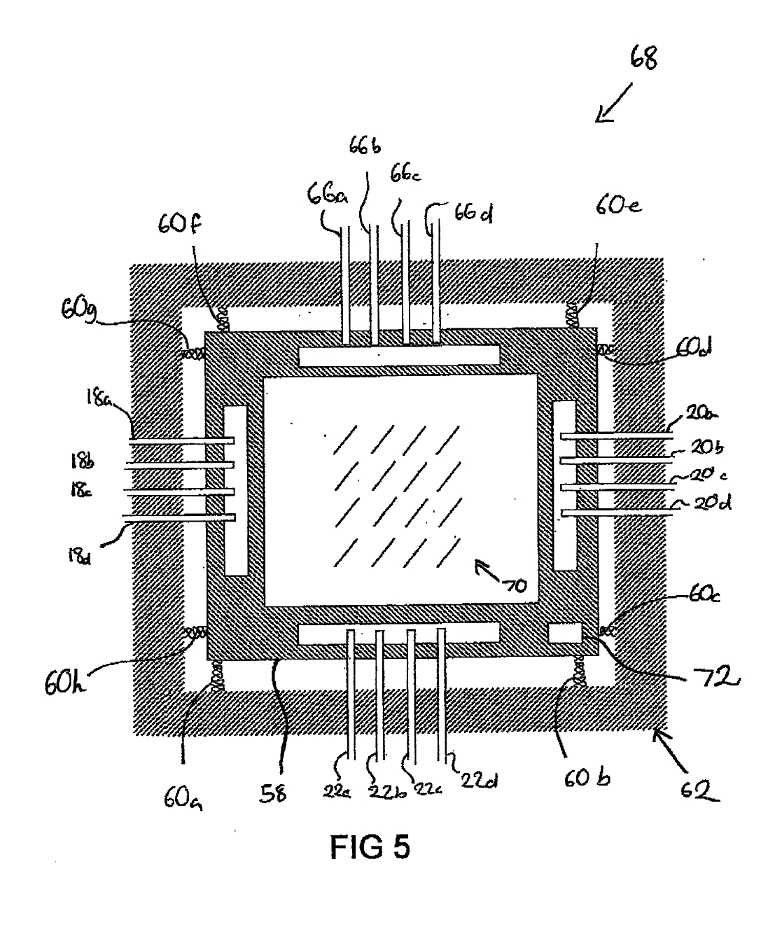

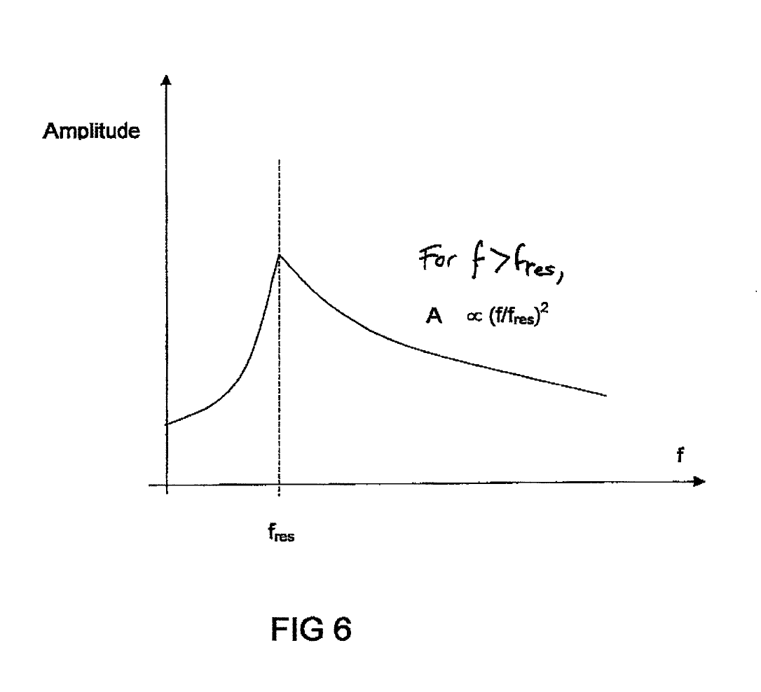

A MEMS stabiliser 58 can passively damp the MEMS device 10 in the case where no active vibration damping is provided, for example, such as FIGS. 4A and 4B illustrate. In these embodiments, a submount 52 is provided which has a sufficiently high inertial mass together with stabilising connectors 60a, 60b to decrease the resonant frequency of the MEMS device as a whole. This results in the frequency of performance degrading vibrational disturbances, such as, for example, caused by traffic or machinery noise falling sufficiently above the resonant frequency for any vibrations induced in the MEMS device to be sufficiently small in magnitude to not affect the performance of the device, for example as FIG. 6 illustrates.

FIG. 6 illustrates how the induced amplitude of disturbance of a MEMS device 68 peaks at the resonant frequency of the MEMS device and declines afterwards. Accordingly, it is desirable to provide a MEMS device in which the resonant frequency is as low as possible to ensure that most sources of disturbance occur at frequencies sufficiently above the resonant frequency and thus do not generate large-amplitude vibrations in the MEMS device.

FIG. 6 illustrates how, above the resonant frequency fᵣₑₛ of the MEMS device, the amplitude A of any vibration decreases, where

$$A = {a}_{0} \frac{{f}_{res}^{2}}{{f}^{2}}$$

Here a₀ is the amplitude of the disturbance and fᵣₑₛ is the resonance frequency of the MEMS device which will be affected by mass of the submount 62 and the stabilising connectors 60a, 60b which provide the connection between the submount 62 and the MEMS platform 58 supporting components of the MEMS device. The resonant frequency fᵣₑₛ of the stabilising connectors can be expressed by

$${f}_{res} = \frac{1}{2 π} \sqrt{\frac{k}{M}}$$

where k is the spring constant of the connectors and M is the mass of the MEMS device.

To ensure that fᵣₑₛ is low, k needs to be small relative to M. This may be difficulty as a small spring constant may not fulfil the physical requirements of the connectors, since manufacturing integrated stabilising connectors using the same technology as that used to manufacture the MEMS platform, i.e., using a monolithic silicon etching process, could result in relatively large k values to ensure the connectors have sufficient strength to support the MEMS device. Nonetheless, providing design constraints permit, passive stabilisation can bye provided. It is furthermore particularly advantageous for the submount 62 to have an inertial mass sufficiently high to shift the resonant frequency of the MEMS device as a whole to below 30 Hz to enable passive damping of frequencies in the range 30 Hz to 60 Hz.

A stabilising connector may comprise a resilient, flexible member formed integrally with the MEMS platform, for example, a silicon element arranged to provide a hair-spring-like biasing action against the MEMS platform. Alternatively a plurality of elements may be provided arranged to provide a compression spring-like biasing action against the MEMS platform.

In FIGS. 4A to 4C, a stabiliser 56 provides support for a MEMS platform 58 by a suitable arrangement of stabilising connectors, of which stabilising connectors 60a, 60b are shown. Other configurations providing appropriate support and stability may be provided in alternative embodiments of the invention, for example, such as FIG. 5 illustrates.

In FIGS. 4A to 4C and in FIG. 5 additional non-biased support for the MEMS platform 58 is not provided. Instead, the MEMS platform is supported by the stabilising connectors 60a, . . . ,g, which are arranged to suitably stabilise the platform.

Referring now to FIG. 4B, MEMS components are shown mounted upon the MEMS platform 58, for example, the MEMS components shown in FIG. 1 may be mounted on top of the MEMS platform 58 according to the invention so as to be passively stabilised against vibration. The MEMS components retain the numbering scheme shown in FIG. 1 for clarity.

In contrast, FIG. 4C shows a side view of a stabiliser 56 having MEMS components provided on a MEMS platform 58, in an embodiment where active camping against vibrational disturbances is provided. In FIG. 4C, the passive vibration damping mechanism of FIG. 4B is supplemented by providing an accelerometer 34 formed integrally with the MEMS platform 58 which provides feedback to a vibration actuator 32.

FIG. 5 shows an overhead view of the stabiliser of FIG. 40, in which resilient members 60a, . . . ,60h support the MEMS platform 58. Optical fibers 18a, . . . ,d, 20a, . . . ,d, 22a, . . . ,d and 60a, . . . ,d are terminated on the MEMS platform 58 to minimise the potential effects of any vibrational disturbance, and a MEMS mirror array 70 is provided on the MEMS platform 58 to enable light signals to be switched from fiber to fiber. Also provided on the MEMS platform 58 is an accelerometer 72. Alternative embodiments may have further means to support the MEMS platform provided underneath the platform (not visible in FIG. 5).

In FIG. 6, the resilient members 60a, . . . ,60h act as cantilevers which support the MEMS platform and the devices attached to the platform. The resilient members 60a, . . . ,60h and the subframe 62 can be formed lithographically and manufactured integrally with other MEMS components. Alternatively, the MEMS platform can be supported on a resilient submount such as a resilient mesh or diaphragm arranged between suitable supports, or alternatively directly or indirectly on a viscoelastic submount. Such submounts may, in addition to providing stabilisation against vibration, also provide shock protection.

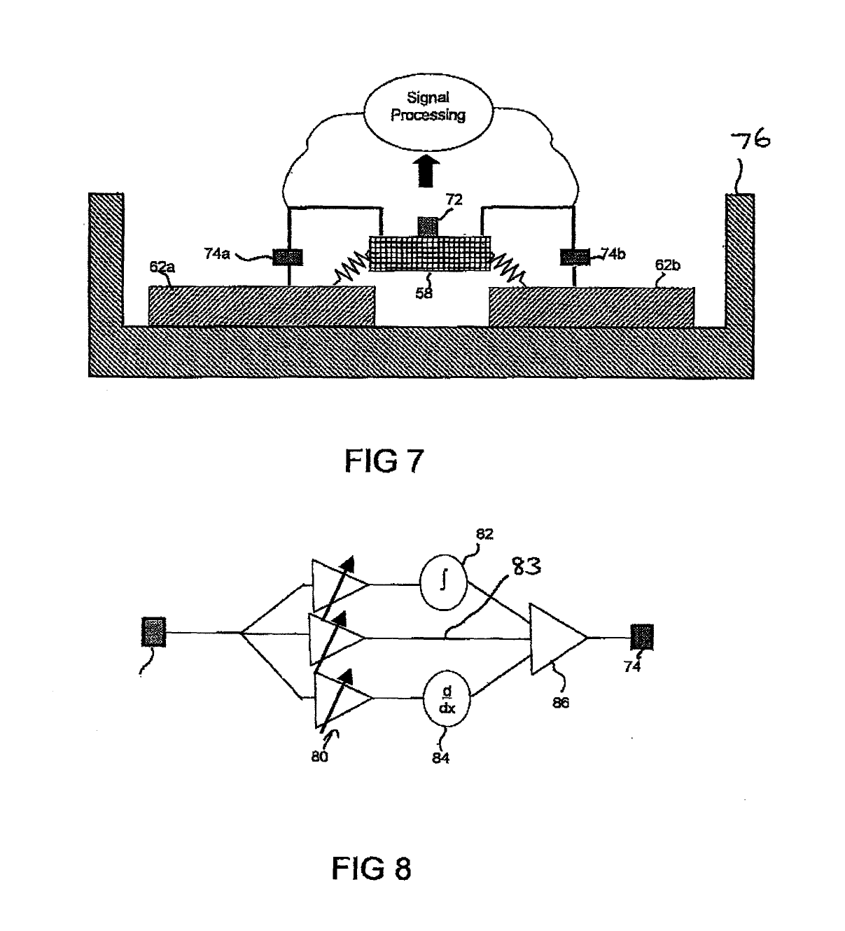

FIG. 7 illustrates schematically how actuators can be provided to provide active stabilisation by generating vibration of a MEMS platform that opposes external vibration, such as FIG. 5 shows for example.

In FIG. 7, a MEMS package 76 is provided for the MEMS device submount 62 and has a plurality of resilient members 60a, . . . , h provided to support a MEMS platform 58 on which MEMS device 68 is provided. The MEMS platform 58 supports all MEMS components which require stabilization to maintain the operational performance of the MEMS device 68, and is connected to vibration actuators 74a, 74b which are capable of vibrating the MEMS platform to damp vibration detected by the accelerometer 72.

Active stabilisation is provided by generating vibration which effectively increases 4 the mass of the MEMS device 68. In accordance with principles known in the art, damping vibrations are generated by the vibration actuator 74a, 74b providing an opposing force to the MEMS platform 58 which is proportional to the measured acceleration.

Without any active component, the MEMS platform and attached components have the following equation of motion

$$m \frac{{ⅆ}^{2} x}{ⅆ {t}^{2}} = - kx .$$

Adding an opposing force

$$F = A \frac{{ⅆ}^{2} x}{ⅆ {t}^{2}}$$

proportional to the acceleration gives

$$m \frac{{ⅆ}^{2} x}{ⅆ {t}^{2}} = - kx - A \frac{{ⅆ}^{2} x}{ⅆ {t}^{2}}$$

as the equation of motion. The resonant frequency fᵣₑₛ of the MEMS platform and components is

$${f}_{res} = \sqrt{\frac{k}{m + A}} or {f}_{res} = \sqrt{\frac{k}{A}}$$

for A>>m. Any suitable mechanical actuator may be used to induce appropriate stabilising vibration, for example, a piezo-drive or transducer producing a force proportional to voltage, for example, as FIG. 8 illustrates.

FIG. 8 shows a schematic feedback circuit for active stabilisation. A signal representing detected vibration by an accelerometer 72 is amplified by variable amplifying means 80. The signal is integrated using a suitable electronic signal integrator 82, and the signal is differentiated using a suitable electronic signal differentiator 84. The signal, the integrated signal 83 from the proportional amplifier 80, and the differentiated signal from the differentiator 84 are input into a summation amplifier 86 which generates an appropriate signal to induce vibration in vibration actuator 74 which opposes the damping induced by other sources. The net vibration the MEMS device undergoes is thus reduced.

Numerous modifications and variations to the features described above in the specific embodiments of the invention will be apparent to a person skilled in the art, The scope of the invention is therefore considered not to be limited by the above description but is to be determined by the accompanying claims.

Any suitable accelerometer may be used to detect vibration of the MEMS device/platform, and a suitable control loop established to actuate a damping actuator providing damping vibration to the MEMS device/platform.

In the best mode of the invention contemplated, the accelerometer is preferably formed integrally with the MEMS platform 20 using a suitable lithographic process. However, the accelerometer may be attached to the MEMS platform 20 in alternative embodiments of the invention. The feedback loop is any suitable for use in conjunction with a suitable, known, actuator to provide vibration at frequencies which will damp the vibration of the MEMS device as a whole.

The MEMS platform support 22 may comprise any suitable material. In one embodiment of the invention, the mass of the MEMS platform is sufficiently high so as to stabilise the MEMS platform. The configuration and arrangement of the MEMS platform and of any suitable support preferably stabilises the MEMS platform. Thus the resilient members are preferably arranged in a symmetrical manner around the centre of mass of the MEMS device/platform to ensure that the device/platform is suitably stable. The flexible resilient members are in the best mode contemplated of the invention, formed using a MEMS manufacturing process, for example, lithographically. The flexible resilient members are sufficiently flexible and resilient to enable the members to flex with any vibration and to compensate for thermal effects.

Addressing the issue of shock in the context of MEMS devices is complicated as the MEMS device needs to be allowed to move to ameliorate the shock sufficiently. Thus, given the scale of typical MEMS devices, simply damping a MEMS device will not, in most cases, be satisfactory. A further, viscous, damping mechanism is required to reduce the extent of movement the MEMS device must undergo to ameliorate the shock. In this manner, movement can be limited to a displacement from rest of less than 16 mm, and preferably less than 3 mm.

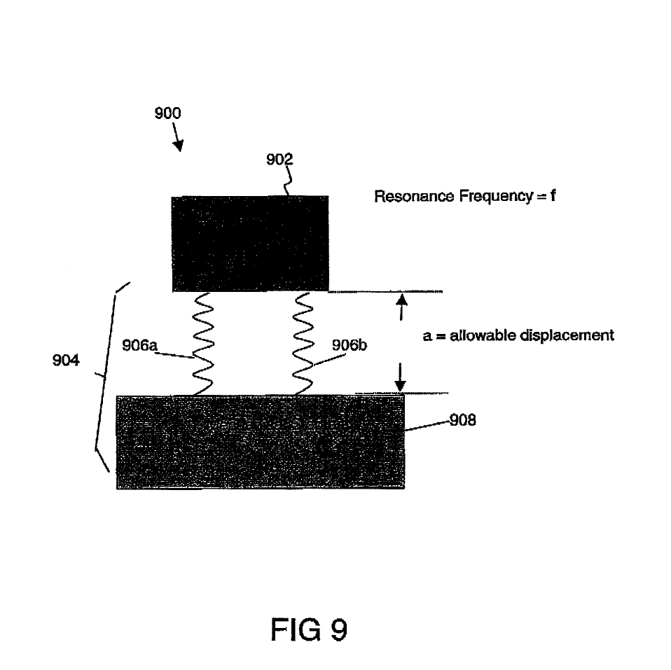

FIG. 9 illustrates one embodiment of the invention in which a MEMS stabilising mechanism 900 provides stabilisation against shock and/or vibration acting oh a MEMS device 902. In FIG. 9, shock is absorbed using a shock absorber 904, and the MEMS device 902 includes a vibrational stabilising mechanism as described herein above. This embodiment provides stabilisation against any type of force acting on the MEMS device 102 is provided, whether shock or vibration. It is also possible to include the vibration stabilising mechanism with the shock absorber 904, or to provide stabilisation against shock only in other embodiments of the invention.

In FIG. 9, the shock absorber mechanism 902 comprises a plurality of resilient members 906a, 906b which are connected to a submount g$ The plurality of resilient members 908a, 906b may comprise micro-mechanical spring mechanisms or, other resilient means, such as a viscoelastic material such as Sorbothane, which can absorb shock applied to the MEMS device. The submount 908 preferably has a sufficiently high inertial mass to act as a mechanical stop. The embodiment shown in FIG. 9 anticipates shock occurring in a vertical plane, obviously, shock occurring along other directions may be provided by laterally providing additional resilient members and a suitable mechanical stop.

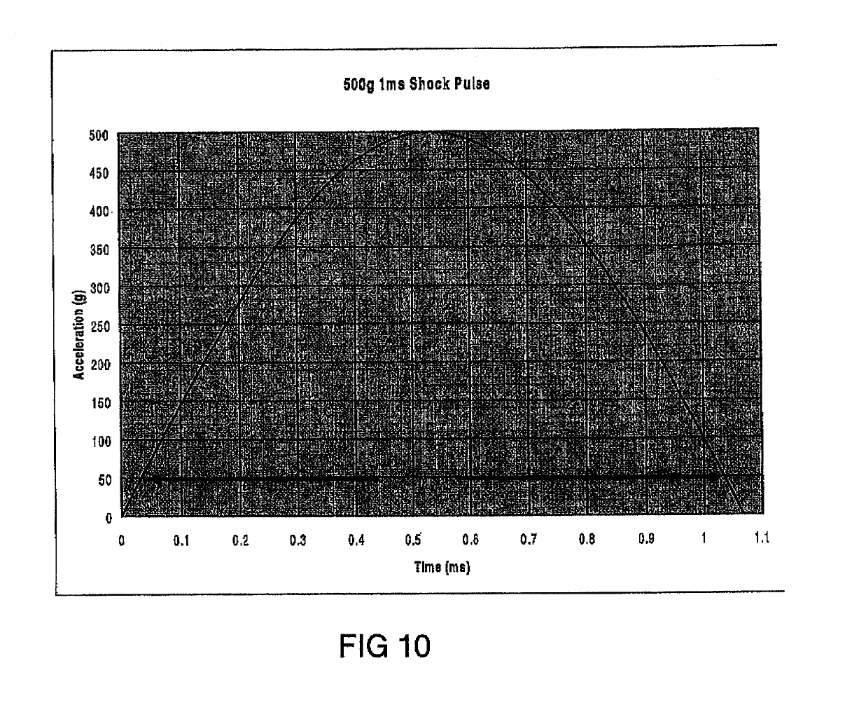

For example, consider the case where MEMS device 902 consists of a plurality of MEMS mirrors and is incorporated in an O×C (Optical Cross-Connect). If the MEMS device is dropped from a certain height the impact of the fall generates a shock. A MEMS device 902 on its own may be able to withstand a certain degree of shock, for example, an acceleration of 250g in 1 ms. However, when incorporated into the O×C and dropped from around 213 of a meter, the MEMS is more likely to experience a shock caused by an acceleration of 500 in 1 ms. Such a shock test specification is sketched in FIG. 10 of the accompanying drawings.

The invention seeks to enable a MEMS device to be compliant with the Bellcore 1221 shock test specification of an acceleration of 500 g with a full width at 10% of 1 ms (equivalent to an impact speed of 3.4 ms⁻¹ or a drop from 0.59 m). If a MEMS device is subjected to such a shock conventionally, the impulse generated by the MEMS device suddenly decelerating from 3.4 ms⁻¹ causes the MEMS actuator or mirror to move enabling it to strike another pad of the structure or to flex and break. In the simple model illustrated in FIG. 17 subjecting the MEMS device 902 to a vertical drop would cause the actuator to move towards the stop or submount 28. The maximum distance moved can be simply calculated as shown by Equation (1) and is determined by the level of shock and the actuator resonance frequency:

$$\frac{{ⅆ}^{2} x}{ⅆ {t}^{2}} + {ω}_{MEMS}^{2} x = a ( t ) \qquad ( 1 )$$

where a(t) is the acceleration imparted by the shock pulse.

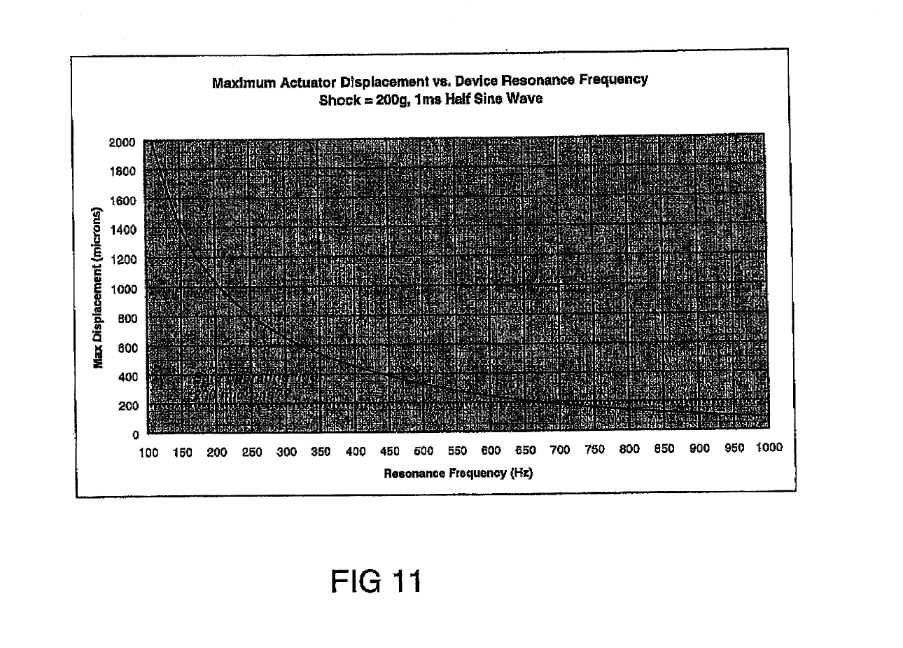

For an acceleration of 200 g in 1 ms, a half sine wave shock, FIG. 11 illustrates the maximum displacement value vs. actuator resonant frequency. Whilst it is unlikely that a MEMS device itself shall exhibit a lowest fundamental resonance frequency below 500 Hz, components of the MEMS device, such as an actuator for a MEMS mirror may have different resonant frequencies. As FIG. 11 illustrates, with a 500 Hz resonant frequency, an actuator would move about 0.4 mm as FIG. 11 shows, which is not an acceptable level displacement.

In order to minimise displacement, for example, to a level of at most 200 microns, an actuator resonance frequency must be kept to about 670 Hz or above. To provide such a resonance frequency, the basic model illustrated in FIG. 9 needs to be modified by providing a dashpot mechanism.

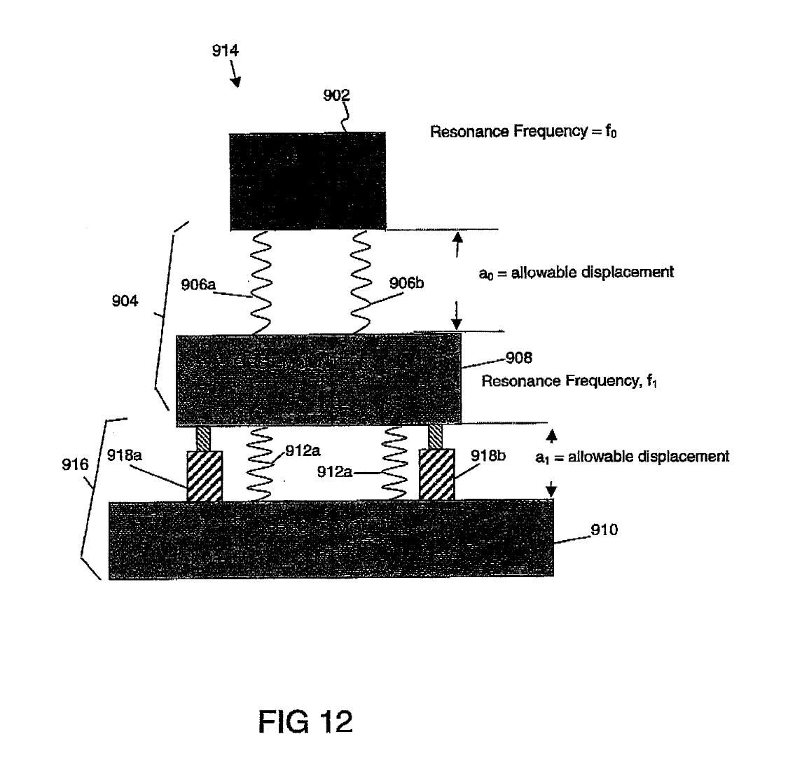

FIG. 12 shows a model of a MEMS stabilising mechanism 914 according to the invention, in which the shock absorber mechanism 904 further includes a dashpot mechanism 916 to ensure that the displacements a₀ and a₁ of the MEMS device as it undergoes shock are retained within acceptable levels.

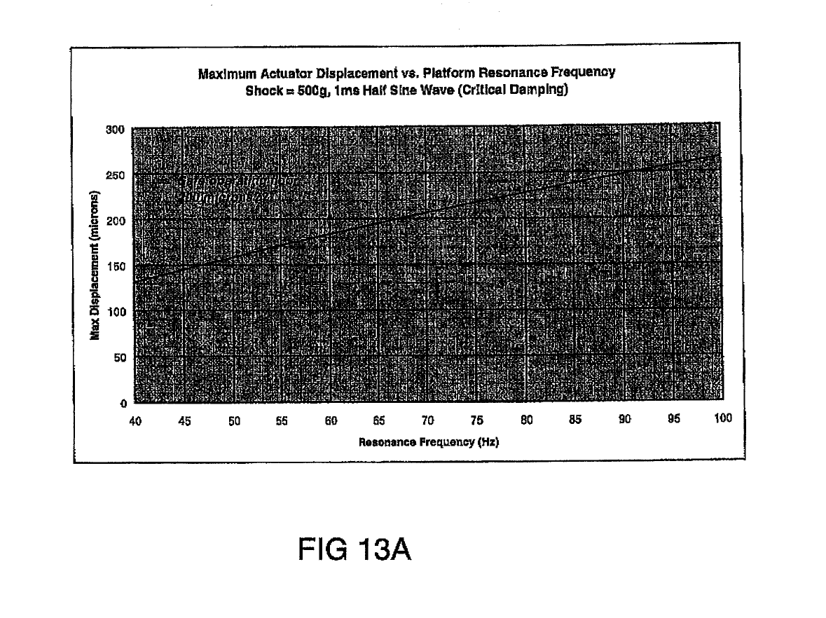

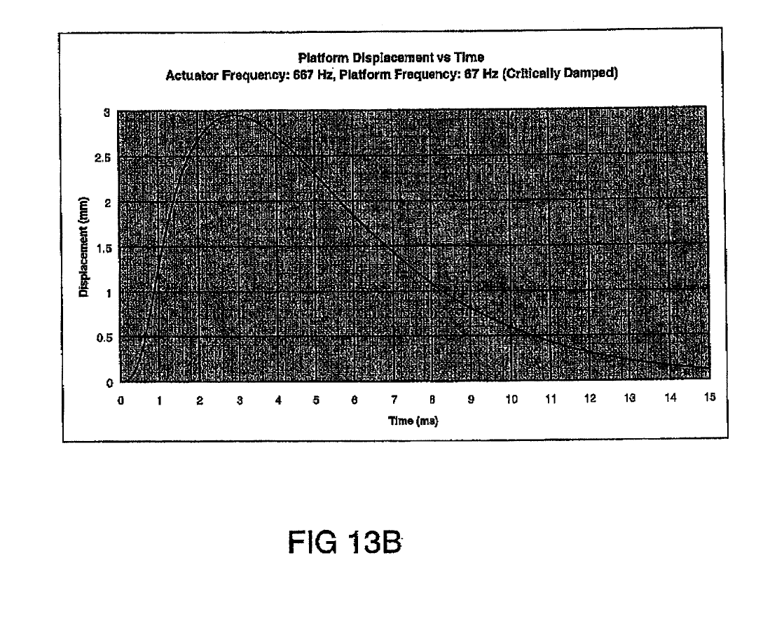

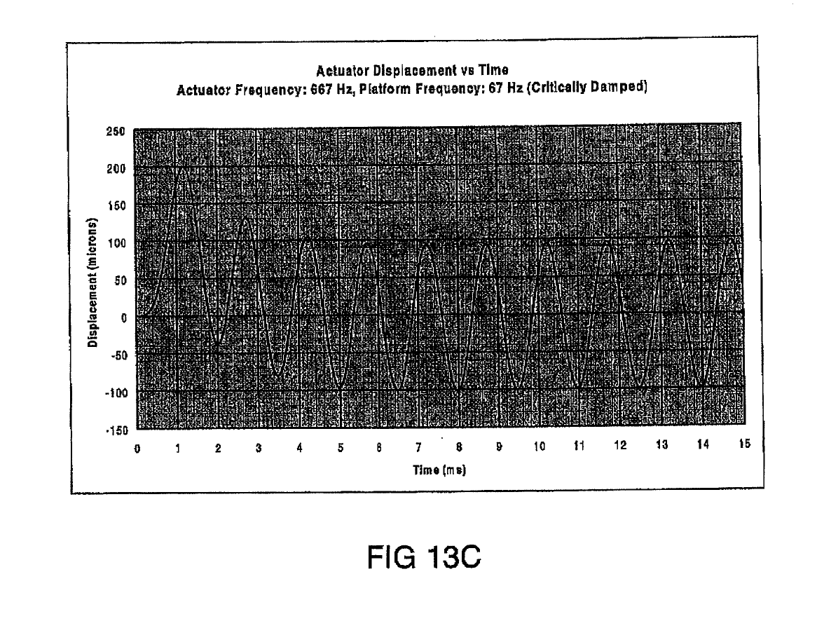

In FIG. 12, the elements shown are like Y those shown in FIG. 9 and retain the same numbering scheme. In FIG. 12, the MEMS device 902 illustrated in FIG. 9 is connected to a first submount 908 by resilient members 906a, 906b. The first submount 908 acts as a stop for the HEMS device, and is connected to a second submount 910 using suitably compliant linkage, for example, dashpot mechanism 916. The dashpot mechanism 916 comprises resilient members 912a, 912b and dashpots 918a, 918b. The equation of motion governing the first submount 908 is, assuming critical damping, provided by Equation (2):

$$\frac{{ⅆ}^{2} x}{ⅆ {t}^{2}} + 2 {ω}_{plat .} \frac{ⅆ x}{ⅆ t} + {ω}_{plat}^{2} x = a ( t ) \qquad ( 2 )$$

where a(t) is the shock pulse acceleration. Using conventional techniques to solve this equation, solutions can be found to determine the kind of compliant mounting required. The solutions are-plotted in FIGS. 13, B, and C. FIG. 13A illustrates the maximum actuator displacement vs. platform resonance frequency for a 500 g, 1 ms half sine wave shock, FIG. 13B illustrates platform displacement vs. time, and FIG. 13C illustrates actuator displacement vs. time. FIG. 13B shows that a maximum platform resonance of 67 Hz is necessary to keep the maximum displacement of the platform to below 3 mm.

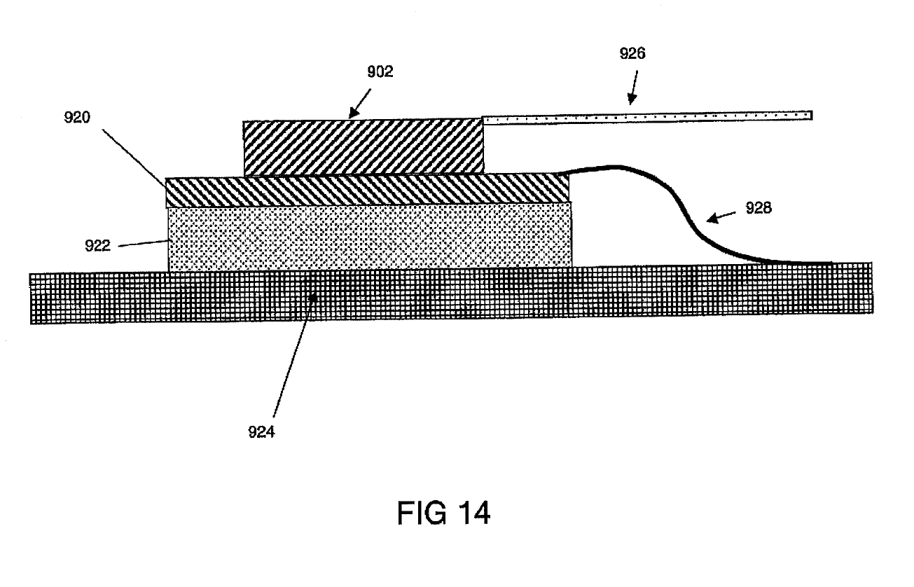

FIG. 14 shows a MEMS device 100 having a stabilising mechanism according to the invention which isolates a MEMS component 102 from vibration and/or shock. In FIG. 14, a MEMS component 902 is mounted on a printed circuit board submount 920. In FIG. 14, a shock absorbing mechanism 922 is provided by mounting the MEMS component 902 directly on a viscoelastic block, which acts as a dashpot mechanism. The shock absorbing mechanism 922 is then mounted on a printed circuit board 924.

Optical connections 926 to the MEMS device can be provided in a manner which is able to accommodate displacement of the MEMS device during shock and/or vibration, for example, by providing some slack in a fibre connection. Similarly, flexible electrical connections 928 are provided between the MEMS device 902 and the PCB 924. The flexible (for example polyamide) circuits enable strain relief between PCB 924 and the MEMS device 902. Similarly, any fibres providing optical connections can be fixed to the MEMS component at points which allow strain relief and control the bend radius without impacting the overall mechanical stiffness.

In the embodiment of the invention illustrated in FIG. 14, the dashpot mechanism comprises a viscoelastic material such as Sorbothane which is interposed between the MEMS component 902 and the PCB 924.

Such a shock absorber may be retro-fitted in some embodiments of the invention. It is possible to combine a vibrational damping mechanism as described hereinabove at the MEMS sub-component level with an appropriate shock absorbance mechanism for a complete component. In this manner, optical switches containing MEMS components can be provided with a vibrational and shock protection system. The invention thus provides protection both during transport and installation of MEMS devices against large amplitude shock-like disturbances which could damage the performance of the device and against smaller amplitude, longer duration disturbances during operation of the device which may otherwise degrade the performance of the device.

The skilled man will appreciate that the invention recognises that MEMS components require protection against shock and/or vibration, and that it is advantageous if such protection can be provided in a form which integrates with the MEMS device. By providing submounts which are highly damped the MEMS components under go a much lower amplitude disturbance and quickly return to equilibrium after any shock/vibrational input.

As MEMS components can be subjected to a variety of temperature ranges, it is highly advantageous if any stabilising mechanism provides consistent stabilisation over a wide temperature range, for example, from −40° C. to 85° C.

The skilled man will further appreciate that received signal latency and feedback signal latency, and the actuator arm movements and other self-induced vibrations may need to be considered in the provision of dynamic damping and/or dynamic shock compensation.

The text of the Abstract repeated here below is hereby incorporated into the description:

An integrated MEMS stabiliser comprises a MEMS platform connected to at least one submount and integrated support means for the MEMS platform including a vibration stabilisation mechanism. The vibration stabilisation mechanism provides at least one connection between the submount and the MEMS platform, and reduces the amplitude of any external vibration experienced by the MEMS platform The stabilisation mechanism provided by the stabiliser enables any MEMS device or component formed or attached to the MEMS platform to maintain its operational performance even when exposed to vibrational disturbance. The stabilisation mechanism may further provide protection against shock, for example, by monitoring the integrated MEMS stabiliser on a slab of suitable visco elastic material, e.g. Sorbothane™.

1. A micro mechanical systems (MEMS) stabiliser for a MEMS component, the stabiliser comprising; at least one submount; and at least one stabilising connection connecting the submount to the MEMS component, wherein the Deciliter provides a stabilisation mechanism to reduce the amplitude of a force displacing the MEMS component from its equilibrium position.

2. A stabiliser as claimed in claim 1, wherein the force acts as 8 shock on the MEMS component.

3. A stabiliser as claimed in claim 1, wherein the force acts as a vibrational disturbance on the MEMS component.

4. A stabiliser as claimed in claim 1, wherein the stabiliser is integrated with the MEMS component.

5. A stabiliser as claimed in claim 1, wherein the stabiliser further comprises at platform for supporting the MEMS component supported by at least one stabilising connection taken from the group including; a resilient member, a cantilevered member.

6. A stabiliser as claimed in claim 1, the stabiliser further comprises at platform for supporting the MEMS component supported by at least one stabilising connection comprising a viscoelastic material.

7. A stabiliser as claimed in claim 1, wherein the force acts as a vibrational disturbance on me MEMS component and wherein the stabilising mechanism includes: a vibration detector detecting vibration of the MEMS component; and a vibrator providing vibrations which damp detected vibrations in accordance the feedback from the vibration detector.

8. A stabiliser as claimed in claim 1, wherein the force acts as a vibrational disturbance on the MEMS component and wherein the stabilising mechanism includes: an accelerometer detecting vibration of the MEMS component; and a vibrator providing vibrations which damp detected vibrations in accordance the feedback from the vibration detector.

9. A stabiliser as claimed in claim 1, wherein the force acts as a vibrational disturbance on the MEMS component and wherein the stabilising mechanism includes, an accelerometer detecting vibration of the MEMS component which degrade the performance of the MEMS component; and a vibrator providing vibrations which damp detected vibrations degrading the performance of the MEMS component in accordance the feedback from the vibration detector.

10. A stabiliser as claimed in claim 1, wherein the submount has a resonant frequency below 30 Hz, and wherein the stabilising mechanism stabilises the MEMS component from vibration at frequencies above 30 Hz.

11. A stabiliser as claimed in claim 1, wherein the submount has a resonant frequency below 10 Hz, and wherein the vibration stabilising mechanism stabilises the MEMS component from vibration at frequencies above 10 Hz.

12. A method of manufacturing an integrated stabiliser for a MEMS device, the method comprising integrating at least one submount and at least one stabilising connection connecting the submount to a component of the MEMS device with components of the MEMS device during manufacture of the MEMS device, wherein the stabiliser provides a stabilisation mechanism to reduce the amplitude of a force displacing the MEMS device from its equilibrium position.

13. A method of manufacturing a stabilised MEMS device, comprising the step of integrating the manufacture of a stabiliser with the step of manufacturing at least one component of the MEMS device.

14. An integrated MEMS accelerometer for detecting vibration of a MEMS component, the accelerometer being provided integrally with a MEMS platform attached to the MEMS component.

15. An integrated MEMS accelerometer as claimed in claim 14 included in a vibration detection mechanism providing feedback to a vibrator providing vibrations which damp detected vibrations.

16. A stabilising connector for connecting a MEMS component to a submount, the stabilising connector comprising a resilient member formed integrally with the MEMS component.

17. A stabilising connector as claimed in claim 16, comprising a resilient member.

18. A stabilising connector as claimed in claim 16, comprising a resilient, silicon based member.

19. A stabilising connector as claimed in claim 16, comprising a resilient, silicon based member providing a cantilever-like connection between the MEMS component and the submount.

20. A stabilising connector as claimed in claim 16, comprising a resilient, silicon based member providing a spring-like connection between the MEMS component and the submount.

21. A biasing MEMS member comprising a plurality of resilient, flexed, elements arranged in juxtaposition such the overall arrangement of elements provides providing a biasing action, wherein each element can be formed by a monolithic process.

22. A biasing MEMS member as claimed in claim 23, for a MEMS device, wherein the biasing MEMS member is formed integrally with at least one component of the MEMS device.

23. A vibration stabilised MEMS component mounted on a MEMS platform connected to at least one submount and including integrated support means for the MEMS platform including a vibration stabilising mechanism, wherein the vibration stabilising mechanism provides at least one stabilising connection between the submount and the MEMS platform, wherein the vibration stabilising mechanism reduces the amplitude of any external vibration experienced by the MEMS component.

24. A MEMS component as claimed in claim 25, wherein the vibration isolation system comprises a vibration actuator and vibration detection means, whereby active feedback from the vibration detecting means controls the amount of vibration induced by the vibration actuator, to actively damp vibration from external sources which are affecting the performance of the MEMS component.

25. A micro mechanical systems (MEMS) stabiliser for a MEMS platform, the stabiliser comprising: at least one submount; and at least one stabilising connection connecting the sub mount to the MEMS platform, wherein the stabiliser provides a vibration stabilisation mechanism to reduce the amplitude of any vibrational disturbance acting on the MEMS platform.

26. A stabiliser as claimed in claim 27, wherein the stabiliser is integrated.

27. A MEMS optical switch incorporating at least one micro mechanical systems (MEMS) stabiliser for a MEMS component of the MEMS optical switch, the stabiliser comprising: at least one submount; and at least one stabilising connection connecting the submount the MEMS component, wherein the stabiliser provides a vibration stabilisation mechanism to reduce the amplitude of any vibrational disturbance acting on the MEMS component.

28. A micro mechanical systems (MEMS) shock absorber for a MEMS component, the shock absorber connected to said MEMS component, the shock absorber comprising at least one submount, and at least one stabilising connection connecting said one of said at least one submounts to the MEMS component, wherein the shock absorber provides a shock stabilisation mechanism to reduce the amplitude of any shock acting on the MEMS component.

29. A shock absorber as claimed in claim 30, wherein the shock absorber is integrated with the MEMS component.

30. A shock absorber as claimed in claim 30, wherein the shock absorber further comprises a second submount connected to the said first submount by at least one resilient member providing a dashpot mechanism for said first submount.

31. A shock absorber as claimed in claim 30, wherein at least one stabilising connection comprises a resilient member.

32. A shock absorber as claimed in claim 30, wherein the MEMS component is stabilised against vibration by a vibration stabilising mechanism provided integrally with said MEMS component.

33. An optical switch including at least one MEMS component and having a micro-mechanical vibration and shock protection system including at least one MEMS stabiliser comprising at least one stabilising submount; and at least one stabilising connection connecting the stabilising submount the MEMS component, wherein the stabiliser provides a vibration stabilisation mechanism to reduce the amplitude of any vibrational disturbance acting on the MEMS component; and at least one MEMS shock absorber for the MEMS component, the shock absorber comprising: at least one submount; and at least one stabilising connection connecting the submount to the MEMS components wherein the shock absorber provides a shock stabilisation mechanism to reduce the amplitude of any shock acting on the MEMS component.
